(19) United States
(12) Patent Application Publication
(10) Pub. No.: US 2026/0126144 A1
(43) Pub. Date: May 7, 2026

(54) EXTERIOR-INSTALLABLE POLY COUPLER SYSTEM FOR USE WITH IRRIGATION SPANS

(71) Applicant: Valmont Industries, Inc., Omaha, NE (US)

(72) Inventor: Cory J. Dillon, Arlington, NE (US)

(73) Assignee: Valmont Industries, Inc., Omaha, NE (US)

(21) Appl. No.: 19/367,893

(22) Filed: Oct. 24, 2025

Related U.S. Application Data
(60) Provisional application No. 63/716,773, filed on Nov. 6, 2024.

(51) Int. Cl. F16L 41/14

(52) U.S. Cl. CPC F16L 41/14

(57) ABSTRACT

An exterior-installable poly coupler system for use in irrigation systems. According to a first preferred embodiment, the poly-coupler system of the present invention includes a main coupler body and a coupler insert which are engineered to allow installation from the exterior of the pipe. According to a further preferred embodiment, the main coupler body of the present invention preferably includes a head with internal ratchet teeth and a lower section with tapered segments. According to a further preferred embodiment, the coupler insert of the present invention preferably may include an insert head, an insertion stem, and a flange with ratchet pawls for secure engagement.

### RELATED APPLICATIONS

The present application claims priority to U.S. Provisional Application No. 63/716,773 filed Nov. 6, 2024.

### BACKGROUND AND FIELD OF THE PRESENT INVENTION

### FIELD OF THE PRESENT INVENTION

The present invention relates generally to irrigation machines and, more particularly, to an exterior-installable poly coupler system for use in irrigation systems.

### BACKGROUND OF THE INVENTION

Modern field irrigation machines are combinations of drive systems and sprinkler systems. Common irrigation machines most often include an overhead sprinkler irrigation system consisting of several segments of pipe (usually galvanized steel or aluminum) joined together and supported by trusses, mounted on wheeled towers with sprinklers positioned along its length. These machines move in a circular pattern (if center pivot) or linear and are fed with water from an outside source (i.e., a well or water line). The essential function of an irrigation machine is to transport water (and other applicants) from a water source to a given location.

An important connection point for distributing water through an irrigation span involves the connection of sprinkler components and nozzles to the main irrigation span. These components attach to couplers which are attached to openings created in the top surface of the irrigation span. The current design of these couplers requires access to the interior of the span to install and maintain. To get this access requires significant mechanical know-how and the installation process is labor-intensive and time-consuming. This complexity increases installation costs and introduces potential difficulties in ensuring proper coupling integrity, especially in long-span irrigation systems. What is needed is an improved coupler which can allow for quick nozzle installation and maintenance.

### SUMMARY OF THE DISCLOSURE

To minimize the limitations found in the prior art, and to minimize other limitations that will be apparent upon the reading of the specifications, the present invention provides an exterior-installable poly coupler system for use in irrigation systems.

According to a first preferred embodiment, the poly-coupler system of the present invention includes a main coupler body and a coupler insert which are engineered to allow installation from the exterior of the pipe.

According to a further preferred embodiment, the main coupler body of the present invention preferably includes a head with internal ratchet teeth and a lower section with tapered segments. According to a further preferred embodiment, the coupler insert of the present invention preferably may include an insert head, an insertion stem, and a flange with ratchet pawls for secure engagement.

According to a further preferred embodiment, the main coupler body of the present invention will preferably include a tapered section that will be internally threaded. Further, the main coupler body may preferably include a locating tab to ensure proper installation and prevent spinning when being installed.

According to a further preferred embodiment, the poly-coupler of the present invention allows for exterior installation, thereby addressing the limitations of current internal installation methods. The improved assembly of the present invention ensures secure and efficient coupling, reducing installation time and enhancing the overall performance of irrigation systems.

### BRIEF DESCRIPTION OF THE DRAWINGS

FIG. 1 illustrates an exemplary self-propelled irrigation system that may be used with implementations of the present invention.

FIG. 2 is an illustration of an exemplary coupler assembly of the present invention.

FIG. 3 is a perspective view of an exemplary main body coupler including a main body head and a lower section in accordance with a first preferred embodiment of the present invention.

FIG. 4 is a perspective view of an exemplary coupler insert including an insert head and insert stem in accordance with a first preferred embodiment of the present invention.

FIG. 5A illustrates the pre-insertion position of a coupler insert in accordance with a first preferred embodiment of the present invention.

FIG. 5B illustrates a post-insertion position of a coupler insert in accordance with a first preferred embodiment of the present invention.

FIG. 6 is a first perspective view of a pair of coupler assemblies in a first pre-insertion position and a post-insertion position.

FIG. 7 is a top-down view of an inserted coupler insert.

FIG. 8 is an enlarged view of the section indicated in FIG. 7.

FIG. 9 is a perspective view of an exemplary coupler assembly of the present invention inserted within an irrigation span in accordance with a first preferred embodiment of the present invention.

FIG. 10 is a top-down view of an exemplary opening formed within an irrigation span for insertion of the exemplary coupler assembly of the present invention.

### DESCRIPTION OF THE PREFERRED EMBODIMENTS

For the purposes of promoting an understanding of the principles of the present invention, reference will now be made to the embodiments illustrated in the drawings and specific language will be used to describe the same. It will nevertheless be understood that no limitation of the scope of the present invention is hereby intended and such alterations and further modifications in the illustrated devices are contemplated as would normally occur to one skilled in the art. The descriptions, embodiments, and figures used are not to be taken as limiting the scope of the claims.

Where the specification describes advantages of an embodiment or limitations of other prior art, the applicant does not intend to disclaim or disavow any potential embodiments covered by the appended claims unless the applicant specifically states that it is “hereby disclaiming or disavowing” potential claim scope. Moreover, the terms “embodiments of the invention”, “embodiments” or “invention” do not require that all embodiments of the invention include the discussed feature, advantage or mode of operation, nor that it does not incorporate aspects of the prior art which are sub-optimal or disadvantageous.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Additionally, any examples or illustrations given herein are not to be regarded in any way as restrictions on, limits to, or express definitions of, any term or terms with which they are utilized. Instead, these examples or illustrations are to be regarded as illustrative only.

As used herein, the singular forms “a”, “an” and “the” are intended to include the plural forms as well, unless the context clearly indicates otherwise. Additionally, the word “may” is used in a permissive sense (i.e., meaning “having the potential to’), rather than the mandatory sense (i.e., meaning “must”). Further, it should also be understood that throughout this disclosure, unless logically required to be otherwise, where a process or method is shown or described, the steps of the method may be performed in any order (i.e., repetitively, iteratively, or simultaneously) and selected steps may be omitted. It will be further understood that the terms “comprises,” “comprising,” “includes” and/or “including”, when used herein, specify the presence of stated features, integers, steps, operations, elements, and/or components, but do not preclude the presence or addition of one or more other features, integers, steps, operations, elements, components, and/or groups thereof.

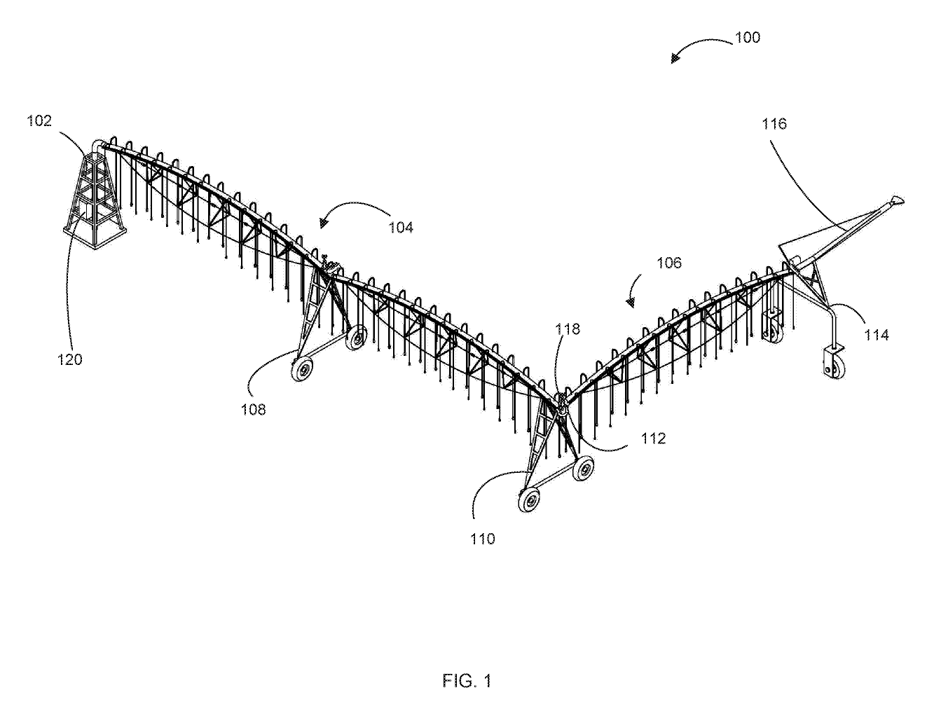

FIG. 1 illustrates an exemplary self-propelled irrigation system 100 which may be used with example implementations of the present invention. As should be understood, the irrigation system 100 disclosed in FIG. 1 is an exemplary irrigation system onto which the features of the present invention may be integrated. Accordingly, FIG. 1 is intended to be illustrative and any of a variety of systems (i.e., fixed systems as well as linear, center pivot and corner systems) may be used with the present invention without limitation.

With reference now to FIG. 1, an exemplary irrigation machine 100 of the present invention preferably may include a center pivot structure 102, a main span 104, and supporting drive towers 108, 110. The exemplary irrigation machine 100 may also include a corner span 106 attached at a connection point 112. The corner span 106 may be supported and moved by a steerable drive unit 114. The corner span 106 may include a boom 116 and an end gun (not shown) and/or other sprayers. Additionally, a position sensor 118 may provide positional and angular orientation data for the system. A central control panel 120 may also be provided and may enclose on-board computer systems for monitoring and controlling the operations of the irrigation machine. The control panel 120 may also be linked to a transceiver for transmitting and receiving data between system elements, device/internet clouds, remote servers and the like.

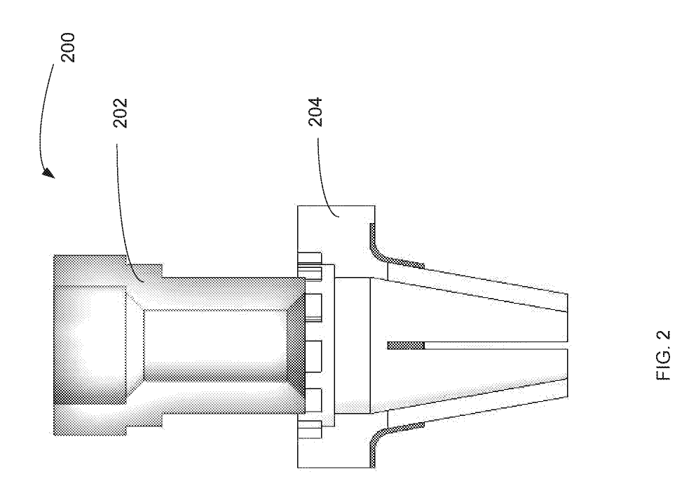

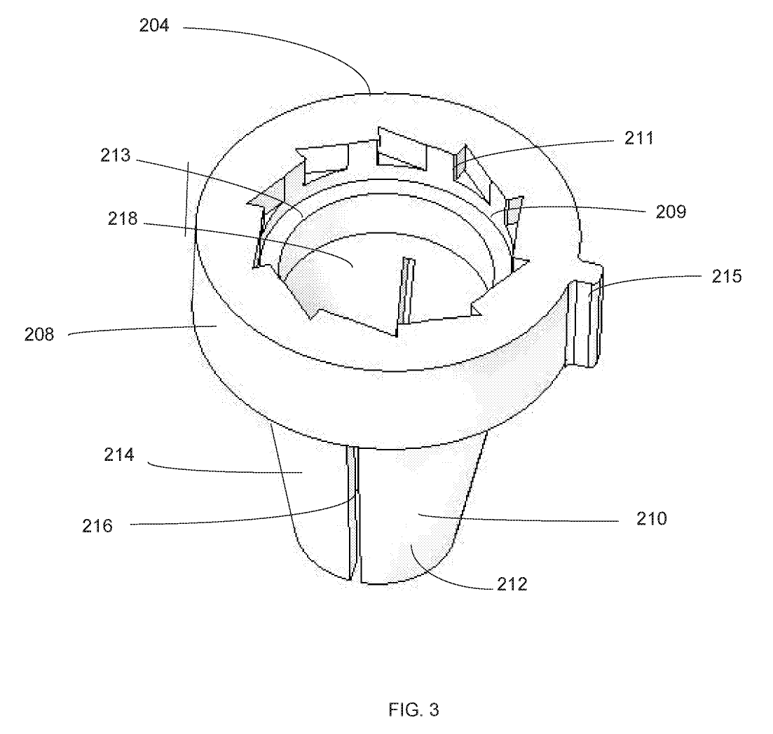

As shown in FIG. 2, coupler assembly 200 of the present invention preferably includes a main coupler body 204 and a coupler insert 202. As shown in FIG. 3, the main body coupler 204 preferably includes a main body head 208 and a lower section 210. The main body head 208 is preferably a circular body forming an internal receiving hole 218. The upper internal surface 209 of the main body head 208 preferably includes internal ratchet teeth 211 which preferably ring the upper internal surface 209 of the main body head 208. The lower internal surface 213 of the main body head 208 is preferably internally threaded. The main body head 208 preferably further includes a locating tab 215.

The lower section 210 of the main body coupler 204 preferably includes one or more tapered segments 212, 214 which preferably are interleaved with one or more reliefs 216 to allow for the expansion of the lower section 210 when the coupler insert 202 is installed as discussed further below.

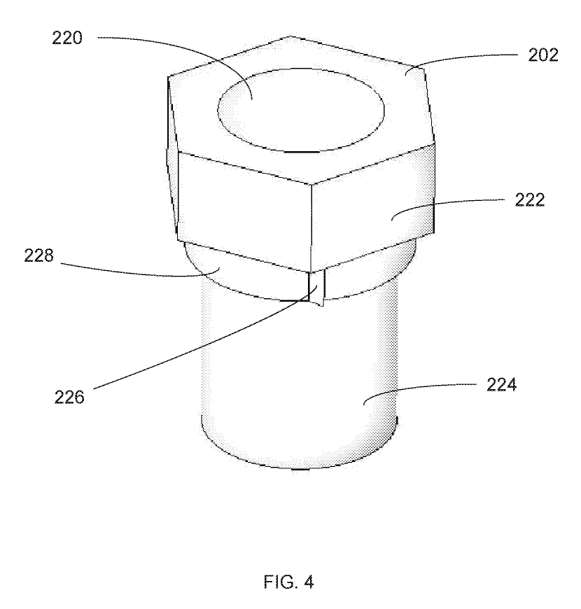

Referring now to FIG. 4, the coupler insert 202 of the present invention preferably may include an insert head 222 and an insert stem 224. Preferably, the coupler insert 202 further includes an insert flange 228 between the insert head 222 and the insert stem 224. According to a preferred embodiment, the insert flange 228 is preferably formed with one or more ratchet pawls 226 extending out from the flange 228. The insert head 222 preferably includes a central pipe insert cavity 220 which preferably may be an internally threaded hole that is formed and sized to receive a drop-down sprinkler base or the like. According to a further preferred embodiment, the insert stem 224 is preferably externally threaded so that it may insert and screw into the lower internal surface 213 of the main body head 208.

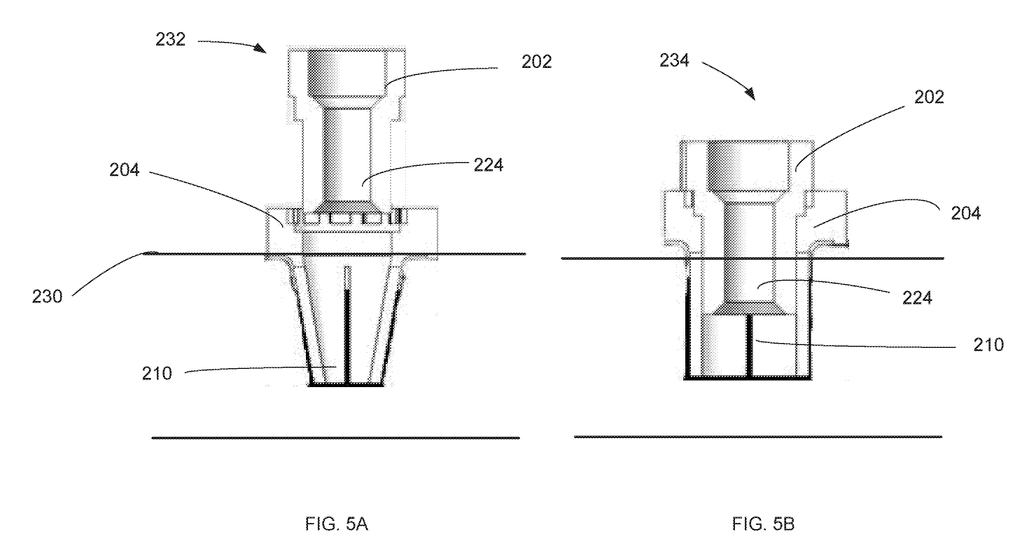

Referring now to FIGS. 5A and 5B, the insertion of the coupler insert 202 into the main body coupler 204 shall now be further discussed. FIG. 5A illustrates a first pre-insertion positioning 232 of the coupler insert 202 with the main body coupler 204 already inserted within an irrigation span 230.

In FIG. 5B, the coupler insert 202 is shown in a second position 234 where the coupler insert 202 has been screwed into the main body coupler 204 such that the insert stem 224 of the coupler insert 202 is pushed down into the lower section 210 of the main body coupler 204.

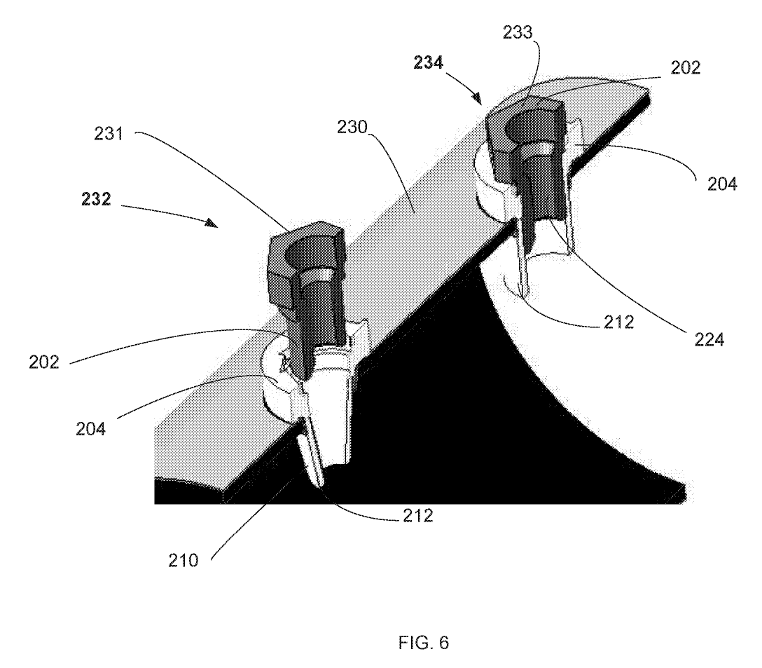

Referring now to FIG. 6, a first perspective view of a pair of coupler assemblies 231, 233 are shown respectively in a first pre-insertion position 232 and a post-insertion position 234. As shown, in the first pre-insertion position 232, the lower section 210 of the main body coupler 204 includes lower segments 210, 212 which are tapered. In the post-insertion position 234, the insert stem 224 is screwed into the main body coupler 204 and the segments 212, 214 of the lower section 210 are pushed outward.

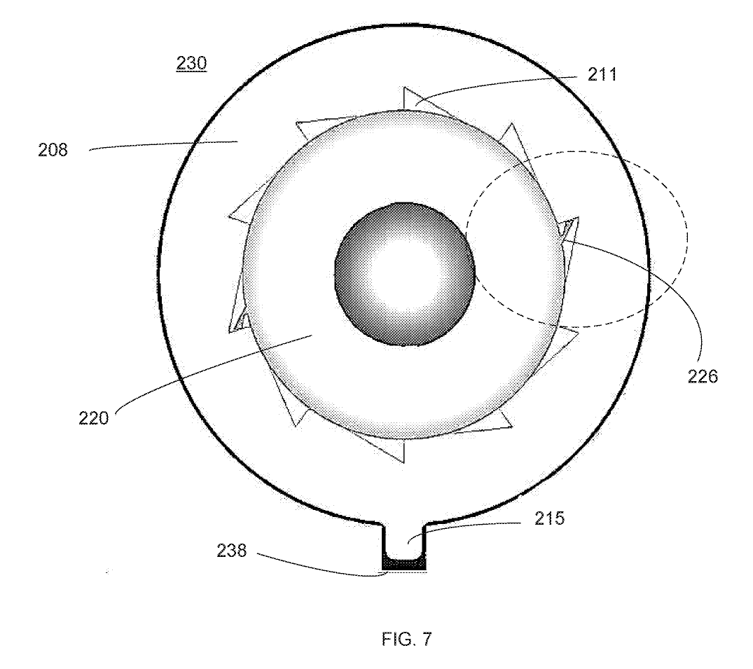

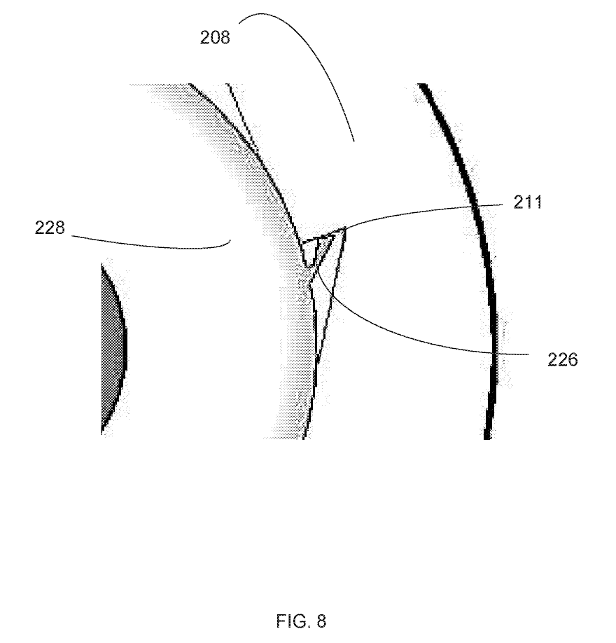

As discussed above, the coupler insert 202 preferably includes an externally threaded coupler stem 224 and an insert flange 228 which preferably includes one or more ratchet pawls 226. Referring now to FIG. 7, a top-down view of an inserted coupler insert 220 is provided. An enlarged view of the section indicated in FIG. 7 is provided in FIG. 8. As shown, the coupler insert 220 is inserted within the coupler main body head 208. As further shown, in this position each ratchet pawl 226 is preferably located to engage one of the ratchet teeth 211 formed in the coupler main body head 208. As further shown, the locating tab 215 of the coupler main body head 208 preferably is locked into place within a locating keyhole 238. In this way, the coupler insert 220 is secured within the coupler main body head 208 to prevent movement of an inserted pipe (not shown) when installed in an irrigation span.

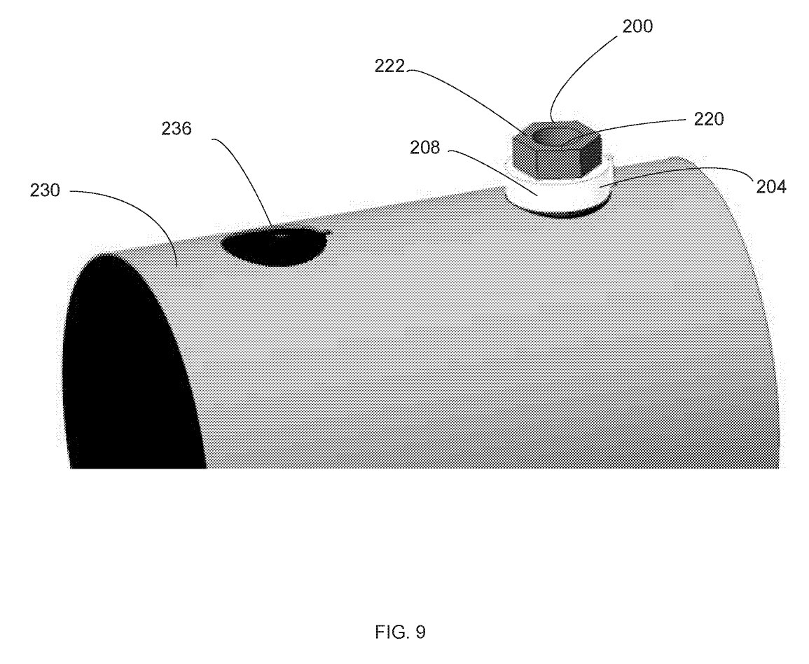

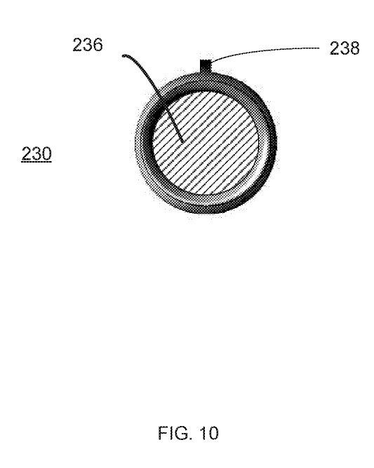

FIG. 9 is a perspective view of an exemplary coupler assembly 200 of the present invention inserted within an irrigation span 230 in accordance with a first preferred embodiment of the present invention. As shown, the coupler insert 220 is fully inserted within the coupler main body 204 so that only the insert head 222 and the coupler main body head 208 are above the span pipe 230 surface. In this position, the coupler assembly 200 is secured and ready for the insertion of a sprayer (not shown) within the insert head 222. As shown in FIG. 9, one or more insertion holes 236 are preferably spaced apart as needed on a given length of span pipe 230. As shown in FIG. 9 and FIG. 10, the insertion holes 236 preferably each may include a locating keyhole 238 to receive the locking tab 215 of an inserted coupler assembly 200.

While the above descriptions regarding the present invention contain much specificity, these should not be construed as limitations on the scope, but rather as examples. Many other variations are possible. For example, the systems of the present invention may be used with any arrangement of irrigation spans, nozzles, sprayers and sprinklers. For example, the present invention may be used with any of a variety of impact sprinklers, spray heads and/or drop hoses. These may include any variety of nozzles including drip irrigation nozzles, wobbler sprinklers and the like without limitation. Accordingly, the scope of the present invention should be determined not by the embodiments illustrated, but by the appended claims and their legal equivalents.

What is claimed is:

1. An exterior-installable poly coupler assembly for an irrigation span pipe, comprising:
a main coupler body configured to be inserted into an opening formed in an irrigation span pipe from the exterior thereof, the main coupler body comprising:
a main body head having internal ratchet teeth disposed on an upper internal surface, internal threads on a lower internal surface, and a locating tab extending from an exterior surface; and
a lower section comprising a plurality of tapered segments interleaved with reliefs to permit radial expansion;
a coupler insert configured to engage with the main coupler body from the exterior of the span pipe, the coupler insert comprising:
an insert head having a central pipe insert cavity configured to receive a sprinkler component;
an externally threaded insert stem dimensioned to threadably engage with the internal threads of the main body head; and
a flange positioned between the insert head and the insert stem, the flange having one or more ratchet pawls disposed to engage the internal ratchet teeth of the main body head.

2. The coupler assembly of claim 1, wherein the locating tab of the main body head is configured to engage a complementary keyhole in the span pipe to prevent rotation of the coupler assembly.

3. The coupler assembly of claim 1, wherein the pipe insert cavity of the insert head is internally threaded and configured to receive an attachment selected from the group of attachments comprising: a drop nozzle, a sprinkler head, and a hose fitting.

4. The coupler assembly of claim 3, wherein the tapered segments of the lower section are radially expandable outwardly in response to axial insertion of the insert stem into the main body head.

5. The coupler assembly of claim 4, wherein the main coupler body and coupler insert are composed of a corrosion-resistant polymeric material.

6. The coupler assembly of claim 4, further comprising one or more sealing elements disposed between the main coupler body and the irrigation span pipe.

7. The coupler assembly of claim 6, wherein the sealing elements comprise at least one gasket formed from an elastomeric material.

8. The coupler assembly of claim 4, wherein the flange of the coupler insert is configured to seat flush with the top surface of the main body head upon full insertion.

9. The coupler assembly of claim 8, wherein the insert stem has a length sufficient to deform and expand the tapered segments of the lower section upon full insertion.

10. The coupler assembly of claim 9, wherein the lower section of the main coupler body comprises interleaved tapered segments and reliefs to facilitate expansion.

11. A method for installing a poly coupler assembly into an irrigation span pipe from the exterior, the method comprising:
forming an opening in the irrigation span pipe, wherein the opening comprises a main hole and a keyhole feature;
inserting a main coupler body into the opening from the exterior of the span pipe, the main coupler body comprising:
a main body head having internal ratchet teeth, internal threads, and a locating tab; and
a lower section with tapered segments interleaved with reliefs;
aligning the locating tab of the main coupler body with the keyhole feature to prevent rotation;
inserting a coupler insert into the main coupler body from the exterior of the span pipe, the coupler insert comprising:
an externally threaded insert stem,
an insert flange having one or more ratchet pawls, and
an insert head with a central pipe insert cavity;
threading the insert stem into the internal threads of the main coupler body to draw the insert into engagement;
expanding the tapered segments of the lower section outwardly as the insert stem is advanced, thereby securing the main coupler body within the span pipe; and
engaging the ratchet pawls of the insert flange with the internal ratchet teeth of the main body head to lock the insert in place.

12. The method of claim 11, further comprising installing a sealing element between the outer surface of the main coupler body and the inner wall of the irrigation span pipe.

13. The method of claim 12, wherein the step of forming the opening comprises cutting a circular hole and a slot extending radially outward to define the keyhole feature.

14. The method of claim 13, further comprising attaching a sprinkler head, nozzle, or drop hose into the central pipe insert cavity of the insert head.

15. The method of claim 14, wherein the main coupler body and the coupler insert are composed of a polymeric material.

16. The method of claim 15, wherein the main coupler body is inserted into a pre-existing irrigation span as a retrofit.
